(19) United States
(12) Patent Application Publication
(10) Pub. No.: US 2022/0016958 A1
(43) Pub. Date: Jan. 20, 2022

(54) VEHICLE

(71) Applicant: HONDA MOTOR CO., LTD., Tokyo (JP)

(72) Inventors: Haruki KOMAZAWA, Tokyo (JP); Toru OGAKI, Tokyo (JP)

(73) Assignee: HONDA MOTOR CO., LTD., Tokyo (JP)

(21) Appl. No.: 17/373,227

(22) Filed: Jul. 12, 2021

(30) Foreign Application Priority Data
Jul. 15, 2020 (JP) 2020-121552

(51) Int. Cl. B60H 1/32; B60L 58/12; B60L 58/26; B60L 53/00; B60H 1/00

(52) U.S. Cl. CPC B60H 1/3205; B60L 58/12; B60H 1/00278; B60L 53/00; B60L 58/26

(57) ABSTRACT

A vehicle includes a vehicle interior, a first temperature adjustment circuit, a battery, a second temperature adjustment circuit a heat exchange part, and a control device. During charging of the battery by the external power supply, the control device is configured to cool the battery by controlling the second temperature adjustment circuit. During charging of the battery by the external power supply, the control device is configured to cool the vehicle interior by controlling the first temperature adjustment circuit when a state of charge of the battery is equal to or greater than a predetermined value and a vehicle interior temperature-related value related to a temperature of the vehicle interior is equal to or greater than a threshold.

### CROSS-REFERENCE TO RELATED APPLICATIONS

This application is based on and claims priority under 35 USC 119 from Japanese Patent Application No. 2020-121552 filed on Jul. 15, 2020.

### TECHNICAL FIELD

The present disclosure relates to a vehicle such as an electric vehicle.

### BACKGROUND ART

In recent years, a vehicle in which a battery is charged with electric power supplied from an external power supply has been known (for example, see WO 2012/153399). In a vehicle disclosed in WO 2012/153399, air conditioning control called pre-air conditioning is performed when charging is not completed according to a charging schedule during external charging of a battery.

On the other hand, attempts have been made to perform both cooling of a vehicle interior and cooling of a battery by one refrigeration system mounted on a vehicle.

When the pre-air conditioning described in WO 2012/153399 is applied to a vehicle which performs both cooling of a vehicle interior and cooling of a battery by using a single refrigeration system, an event in which the battery cannot be appropriately cooled and output of the battery is limited may occur, depending on a usage state of an air conditioner which cools the vehicle interior. For example, when a temperature inside the vehicle interior rises during external charging of the battery and the vehicle travels immediately after charging of the battery, if a large part of cooling capacity of the air conditioner is used to cool the vehicle interior, an event in which the battery is not appropriately cooled and the output of the battery is limited may occur. On the other hand, if the vehicle interior is actively cooled during external charging of the battery, there is a possibility that the battery cannot be appropriately cooled.

### SUMMARY OF INVENTION

The present disclosure provides a vehicle capable of appropriately cooling a battery during external charging and preventing an event in which output of the battery is limited when the vehicle travels immediately after charging of the battery, even in a case where cooling of a vehicle interior and cooling of the battery are performed by a single refrigeration system.

The present invention provides a vehicle, including:

a vehicle interior;

a first temperature adjustment circuit including a compressor, a condenser, an expansion valve, and an evaporator, the first temperature adjustment circuit being configured to cool the vehicle interior;

a battery configured to be charged by receiving electric power from an external power supply;

a second temperature adjustment circuit configured to cool the battery;

a heat exchange part configured to perform heat exchange between a first medium flowing through the first temperature adjustment circuit and a second medium flowing through the second temperature adjustment circuit; and

a control device configured to control the first temperature adjustment circuit and the second temperature adjustment circuit,

in which during charging of the battery by the external power supply, the control device is configured to:
cool the battery by controlling the second temperature adjustment circuit; and
when a state of charge of the battery is equal to or greater than a predetermined value and a vehicle interior temperature-related value related to a temperature of the vehicle interior is equal to or greater than a threshold, cool the vehicle interior by controlling the first temperature adjustment circuit.

In addition, the present invention provides a vehicle, including:

a vehicle interior;

a first temperature adjustment circuit including a compressor, a condenser, an expansion valve, and an evaporator, the first temperature adjustment circuit being configured to cool the vehicle interior;

a battery configured to be charged by receiving electric power from an external power supply;

a second temperature adjustment circuit configured to cool the battery;

a heat exchange part configured to perform heat exchange between a first medium flowing through the first temperature adjustment circuit and a second medium flowing through the second temperature adjustment circuit; and

a control device configured to control the first temperature adjustment circuit and the second temperature adjustment circuit,

in which during charging of the battery by the external power supply, the control device is configured to:
prohibit cooling of the vehicle interior by controlling the first temperature adjustment circuit while charging of the battery is under constant current control; and
permit cooling of the vehicle interior by controlling the first temperature adjustment circuit after charging of the battery is shifted from the constant current control to constant voltage control.

According to the present invention, even when cooling of a vehicle interior and cooling of a battery are performed by a single refrigeration system, the battery can be appropriately cooled during external charging. In addition, when a vehicle travels immediately after charging of the battery, it is possible to prevent output of the battery from being limited.

### BRIEF DESCRIPTION OF DRAWINGS

FIG. 1 is a circuit diagram illustrating a configuration of a temperature adjustment circuit provided in a vehicle according to an embodiment of the present disclosure;

FIG. 2 is a timing chart illustrating an example of control during charging and at the start of traveling of the temperature adjustment circuit illustrated in FIG. 1;

FIG. 3 is a graph illustrating a relationship between a state of charge of a battery and a charging current during external charging;

FIG. 4 is a graph illustrating a relationship between a state of charge of a battery and a heat generation amount of the battery during external charging; and

FIG. 5 is a flowchart illustrating a processing procedure of cooling control during charging.

### DESCRIPTION OF EMBODIMENTS

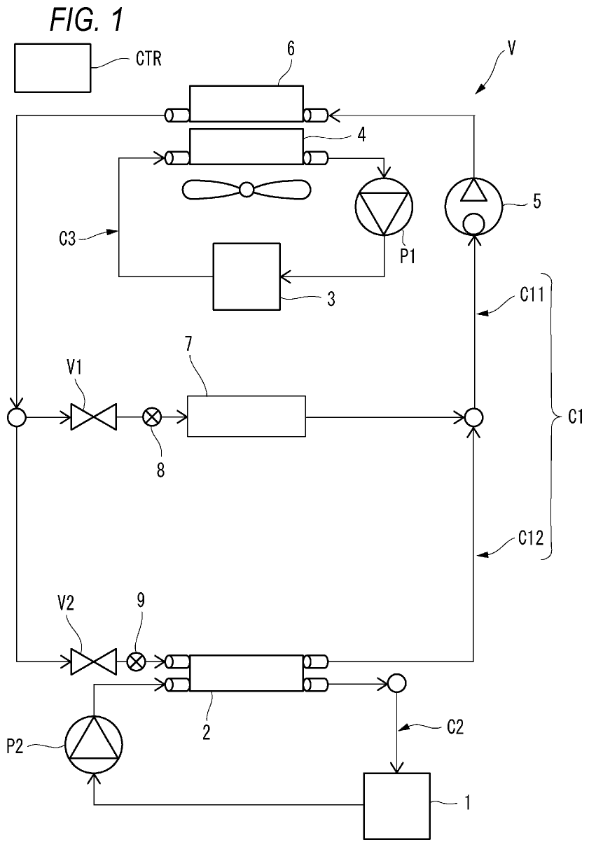

Hereinafter, an embodiment of the present disclosure will be described with reference to FIGS. 1 to 5.

As illustrated in FIG. 1, a vehicle V includes a vehicle interior (not illustrated), a first temperature adjustment circuit C1 which cools the vehicle interior, a battery 1 which can be charged with electric power from an external power supply, a second temperature adjustment circuit C2 which cools the battery 1, a chiller 2 which performs heat exchange between a first medium flowing through the first temperature adjustment circuit C1 and a second medium flowing through the second temperature adjustment circuit C2, a drive unit 3 (including a motor, an inverter, and the like) which causes the vehicle V to travel with electric power from the battery 1, a third temperature adjustment circuit C3 which cools the drive unit 3, and a control device CTR which controls the temperature adjustment circuits C1 to C3.

The first medium is a liquid medium such as a refrigerant gas which vaporizes in a low-pressure environment and liquefies in a high-pressure environment, and the second medium is a liquid medium such as water, a radiator liquid, or a coolant liquid. The third temperature adjustment circuit C3 is configured by arranging a first pump P1, the drive unit 3, and a radiator 4 on a circuit through which a liquid medium circulates, and a detailed description thereof is omitted since a relation thereof with the present invention is insignificant.

The second temperature adjustment circuit C2 includes a second pump P2 which causes the second medium to circulate in this circuit, the chiller 2 which is disposed downstream of the second pump P2 and performs heat exchange between the first medium flowing through the first temperature adjustment circuit C1 and the second medium, and the battery 1 which is disposed downstream of the chiller 2.

The first temperature adjustment circuit C1 includes: a main flow path C11 in which a compressor 5, a condenser 6, an expansion valve 8, and an evaporator 7 are disposed along a flow direction of the first medium; a branch flow path C12 which is branched from the main flow path C11 and connected to the chiller 2; a first valve V1 which is provided in the main flow path C11 and capable of blocking inflow of the first medium to the expansion valve 8 and the evaporator 7; a second valve V2 which is provided in the branch flow path C12 and capable of blocking inflow of the first medium to the chiller 2; and an expansion valve 9 which is provided between the second valve V2 and the chiller 2. The compressor 5, the condenser 6, the evaporator 7, and the expansion valve 8 constitute a so-called refrigeration cycle. This refrigeration cycle is provided only in the first temperature adjustment circuit C1, and is not provided in the second temperature adjustment circuit C2. Therefore, as will be described in detail later, in order to cool the battery 1 using the refrigeration cycle, heat exchange between the first medium and the second medium via the chiller 2 is required.

The first valve V1 and the second valve V2 are, for example, electromagnetic on-off valves which can be electromagnetically switched between ON and OFF, and block inflow of the first medium by OFF and allow inflow of the first medium by ON. The first valve V1 and the second valve V2 may be normally closed valves or normally open valves. The first valve V1 and the expansion valve 8 may be configured with the same valve, and the second valve V2 and the expansion valve 9 may be configured with the same valve.

In the first temperature adjustment circuit C1, in a first state where the first valve V1 and the second valve V2 are ON and inflow of the first medium to the evaporator 7 and the chiller 2 is allowed, the first medium is supplied from the condenser 6 to the evaporator 7 and the chiller 2. The first medium supplied to the evaporator 7 exchanges heat with air, and the air cooled by the heat exchange is supplied to the vehicle interior by a fan (not illustrated). Therefore, the vehicle interior is cooled. On the other hand, the first medium supplied to the chiller 2 exchanges heat with the second medium in the chiller 2, and the second medium cooled by the heat exchange is supplied to the battery 1. Therefore, the battery 1 is cooled. The first medium cools the air or the second medium in the evaporator 7 or the chiller 2 by vaporization heat when the first medium is vaporized in the expansion valves 8 and 9, and the vaporized liquid medium is returned to a liquid state through the compressor 5 and the condenser 6.

In addition, in the first temperature adjustment circuit C1, in a second state where the first valve V1 is ON and the second valve V2 is OFF and only inflow of the first medium to the evaporator 7 is allowed, the first medium is supplied from the condenser 6 only to the evaporator 7, and the vehicle interior is cooled. Further, in the first temperature adjustment circuit C1, in a third state where the first valve V1 is OFF and the second valve V2 is ON and only inflow of the first medium to the chiller 2 is allowed, the first medium is supplied from the condenser 6 only to the chiller 2, and the battery 1 is cooled.

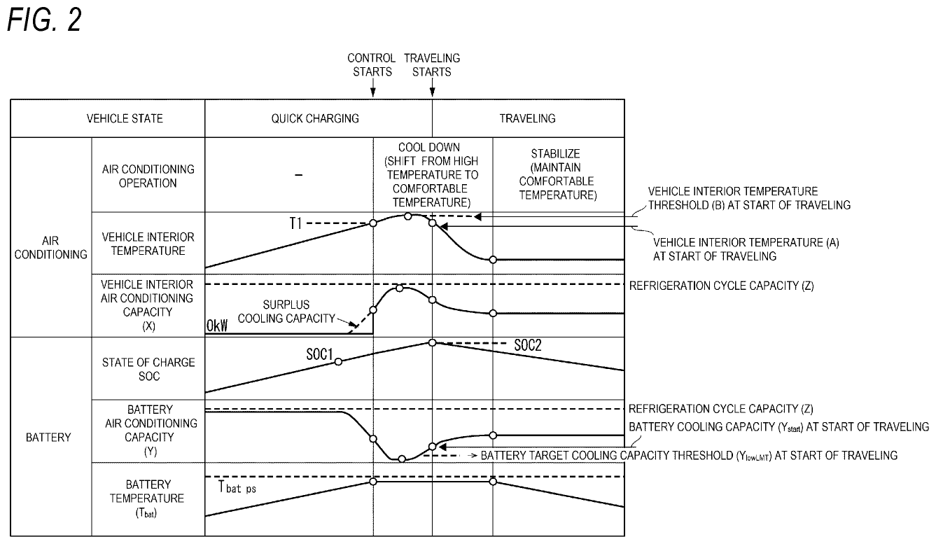

Refrigeration cycle capacity Z (cooling capacity) of the first temperature adjustment circuit C1 is, for example, 3 kw to 10 kw. In the first state, the refrigeration cycle capacity Z is assigned to vehicle interior cooling capacity X (vehicle interior air conditioning capacity in FIG. 2) and cooling capacity Y for the battery 1 (battery air conditioning capacity in FIG. 2). In the second state, the refrigeration cycle capacity Z is used only for the vehicle interior cooling capacity X. In the third state, the refrigeration cycle capacity Z is used only for the cooling capacity Y for the battery 1. The refrigeration cycle capacity Z (cooling capacity) is a maximum cooling capacity which can be realized by a refrigerator in a thermodynamic cycle of the refrigerator using a phenomenon in which heat is taken away from the surroundings when a liquid evaporates and vaporizes. A dominant factor for determining the refrigeration cycle capacity Z is capacity of the compressor 5, but the refrigeration cycle capacity Z is not determined only by the capacity of the compressor 5. The refrigeration cycle capacity is determined by a composite factor such as performance of the condenser 6 which condenses a refrigerant compressed by the compressor 5 and performance of the evaporator 7 which causes the condensed refrigerant to evaporate.

While the battery 1 is charged by the external power supply (during plug-in charging), the control device CTR controls the first temperature adjustment circuit C1 and the second temperature adjustment circuit C2 to cool the battery 1. However, when the temperature in the vehicle interior rises during external charging of the battery 1 and the vehicle V travels after charging of the battery 1, if a large part of the refrigeration cycle capacity Z of the first temperature adjustment circuit C1 is used for vehicle interior cooling (air conditioning), the battery 1 may not be appropriately cooled. Therefore, a battery temperature may rise to a threshold temperature (T_{bat ps} in FIG. 2) at which the output of the battery 1 is limited.

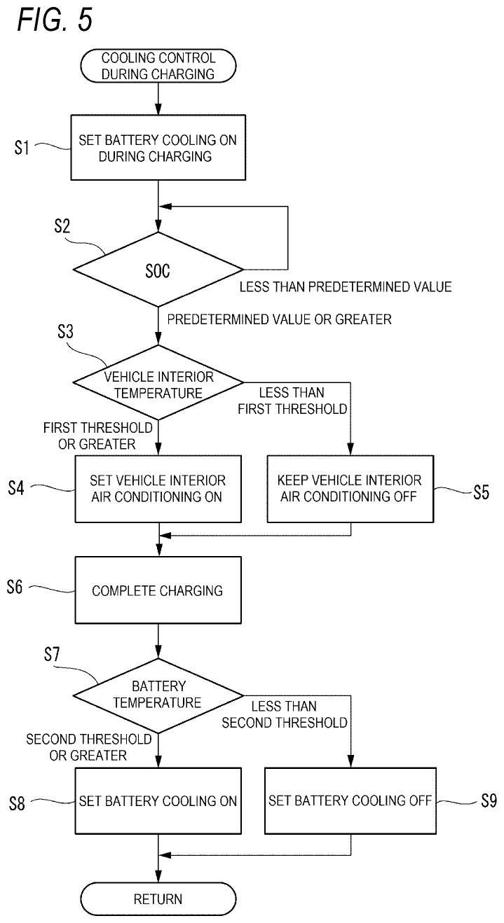

As illustrated in FIGS. 2 and 5, when charging of the battery 1 by the external power supply is started, the control device CTR sets the first temperature adjustment circuit C1 to the third state and uses the refrigeration cycle capacity Z only for the cooling capacity Y for the battery 1, and when a state of charge of the battery 1 is equal to or greater than a predetermined value (for example, the state of charge is equal to or greater than a state of charge SOC1 in FIG. 2) and a vehicle interior temperature-related value related to the temperature of the vehicle interior is equal to or greater than a threshold (for example, the temperature of the vehicle interior is equal to or higher than T1 in FIG. 2), the control device CTR switches the first temperature adjustment circuit C1 to the first state and assigns the refrigeration cycle capacity Z for the vehicle interior cooling capacity X and the cooling capacity Y for the battery 1. The vehicle interior temperature-related value is not limited to a value of the vehicle interior temperature, and may be a value of an outside air temperature, a value of a predicted vehicle interior temperature at the end of charging, or the like.

In this way, by cooling the vehicle interior during charging of the battery 1, it is possible to prevent an event in which the output of the battery 1 is limited due to a large part of the refrigeration cycle capacity Z of the first temperature adjustment circuit C1 being used for cooling the vehicle interior when the vehicle V travels after charging of the battery 1.

In addition, by cooling the vehicle interior only when the state of charge of the battery 1 is equal to or greater than the predetermined value, the vehicle interior can be cooled using surplus cooling capacity of the first temperature adjustment circuit C1 after a heat generation amount of the battery 1 decreases.

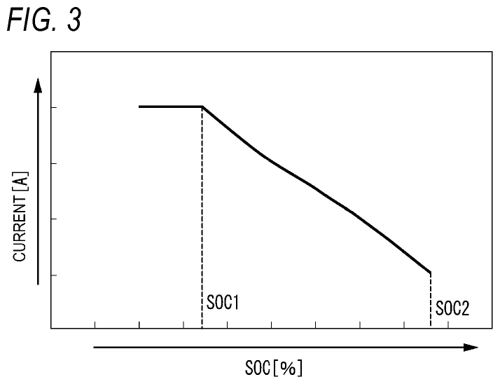

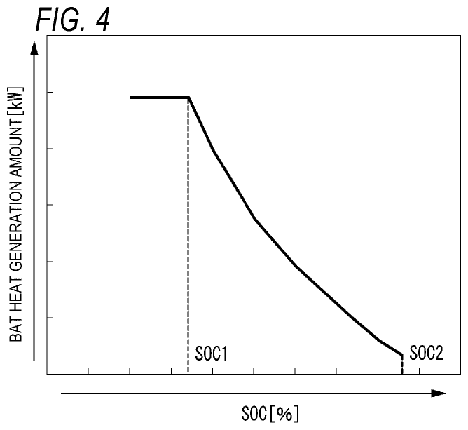

The predetermined value may be set to a state of charge (SOC1) at which shift from constant current control to constant voltage control is performed at the time of charging the battery 1. For example, in the vehicle V, in charging the battery 1 by using the external power supply, as illustrated in FIG. 3, the battery 1 is charged by the constant current control when the state of charge of the battery 1 is small, and the battery 1 is charged by the constant voltage control when the state of charge of the battery 1 approaches a target state of charge (SOC2). According to such charging control, as illustrated in FIG. 4, heat generation during charging of the battery 1 is smaller during the constant voltage control than during the constant current control. Therefore, as illustrated in FIG. 2, the cooling capacity Y of the first temperature adjustment circuit C1 assigned to the cooling of the battery 1 decreases. Therefore, during the constant voltage control, the cooling capacity X (Z−Y) of the first temperature adjustment circuit C1 can be used to cool the vehicle interior.

That is, during charging of the battery 1 by the external power supply, a charging current and the heat generation amount of the battery 1 decrease in accordance with an increase in the state of charge of the battery 1. Therefore, in a situation where the state of charge of the battery 1 is equal to or greater than the predetermined value, the cooling capacity Y required for battery cooling decreases, and a part of the refrigeration cycle capacity Z can be assigned as the cooling capacity X to be used for vehicle interior cooling. In the case where the constant current control is shifted to the constant voltage control in accordance with the state of charge of the battery 1, the vehicle interior can be cooled by the first temperature adjustment circuit C1 after charging of the battery 1 is shifted from the constant current control to the constant voltage control. In this way, it is possible to appropriately cool the battery 1 during charging of the battery 1, and it is possible to prevent an event in which the output of the battery 1 is limited due to the cooling capacity of the first temperature adjustment circuit C1 being used for cooling the vehicle interior when the vehicle V travels immediately after charging of the battery 1.

When cooling the vehicle interior during charging of the battery 1, the control device CTR assigns the refrigeration cycle capacity Z of the first temperature adjustment circuit C1 to cooling of the battery 1 in preference to cooling of the vehicle interior. That is, the cooling capacity X assigned to cooling of the vehicle interior during charging of the battery 1 is limited to be equal to or less than cooling capacity (X≥Z−Y) which is obtained by subtracting the cooling capacity Y required for the battery cooling from the refrigeration cycle capacity Z of the first temperature adjustment circuit C1. As a result, the heat generation of the battery 1 can be preferentially suppressed.

The cooling capacity Y assigned to cooling of the battery 1 during charging of the battery 1 is determined based on a threshold temperature (T_{bat ps} in FIG. 2) at which the output of the battery 1 is limited and based on the temperature (T_{bat} in FIG. 2) of the battery 1 during charging. Specifically, while cooling the battery 1 so that the temperature T_{bat} of the battery 1 during charging does not exceed the threshold temperature T_{bat ps}, the vehicle interior is cooled using the surplus cooling capacity.

When the vehicle V travels after charging of the battery 1, the control device CTR assigns the refrigeration cycle capacity Z of the first temperature adjustment circuit C1 to the cooling of the battery 1 in preference to the cooling of the vehicle interior so that the temperature (T_{bat} in FIG. 2) of the battery 1 does not exceed the threshold temperature (T_{bat ps} in FIG. 2). Specifically, referring to FIG. 2, cooling capacity yₛₜₐᵣₜ for the battery 1 at the start of traveling is equal to or greater than a target cooling capacity threshold Y_{lowLMT} for the battery 1 at the start of traveling, and the target cooling capacity threshold Y_{lowLMT} is determined such that the temperature T_{bat} of the battery 1 is lower than the threshold temperature T_{bat ps}. As a result, it is possible to more appropriately prevent an event in which the output of the battery 1 is limited when the vehicle V travels after charging of the battery 1.

At this time, the cooling of the vehicle interior is preferably set so that a vehicle interior temperature (A) at the start of traveling does not exceed a vehicle interior temperature threshold (B) at the start of traveling.

When the vehicle V does not travel immediately after charging of the battery 1, the control device CTR ends the cooling of the vehicle interior at the end of charging of the battery 1. In this way, it is possible to avoid an occurrence that the state of charge of the battery 1 decreases due to cooling the vehicle interior.

The control device CTR may cool the vehicle interior during charging of the battery 1 only when permission is given by a user. For example, the user may set in advance whether to cool the vehicle interior during charging of the battery 1, and the cooling of the vehicle interior during charging of the battery may be executed only when setting to permit the cooling is made. In this way, it is possible to avoid an occurrence that the vehicle interior is cooled in a state where permission is not given by the user.

In addition, the control device CTR may cool the vehicle interior during charging of the battery 1 when an interval between a scheduled end time of charging of the battery 1 and a traveling start time is equal to or less than a predetermined time based on a charging schedule and a traveling schedule. In this way, unnecessary cooling of the vehicle interior can be avoided.

When cooling the vehicle interior during charging of the battery 1, it is preferable to cool the vehicle interior by using surplus electric power from an external power supply. In this way, in a charging station where a fee is charged according to charging time, charging of the battery 1 and cooling of the vehicle interior can be performed economically and efficiently.

Next, a processing procedure of the control device CTR for implementing the functions as described above will be described with reference to FIG. 5.

As illustrated in FIG. 5, when the battery 1 is charged by an external power supply, the control device CTR sets the first temperature adjustment circuit C1 to the third state to start cooling of the battery 1 (S1), and then repeatedly determines whether a state of charge of the battery 1 is equal to or greater than a predetermined value (S2). When it is determined that the state of charge of the battery 1 is equal to or higher than the predetermined value, the control device CTR determines whether a temperature of the vehicle interior is equal to or higher than a first threshold (S3). When it is determined that the temperature of the vehicle interior is equal to or higher than the first threshold, the control device CTR sets the first temperature adjustment circuit C1 to the first state to start cooling of the vehicle interior (S4). When it is determined that the temperature of the vehicle interior is lower than the first threshold, the control device CTR maintains the first temperature adjustment circuit C1 in the third state (S5).

Thereafter, the control device CTR completes charging according to a charging completion condition (S6), and then determines whether a temperature of the battery 1 is equal to or higher than a second threshold (S7). When it is determined that the temperature of the battery 1 is equal to or higher than the second threshold, the control device CTR sets the first temperature adjustment circuit C1 to the first state or the third state to continue the cooling of the battery 1 (S8). When it is determined that the temperature of the battery 1 is lower than the second threshold, the control device CTR sets the first temperature adjustment circuit C1 to the second state or a stop state to stop the cooling of the battery 1 (S9).

Although the embodiment is described above with reference to the drawings, it is needless to say that the present disclosure is not limited to such an example. It will be apparent to those skilled in the art that various changes and modifications may be conceived within the scope of the claims. It is also understood that the various changes and modifications belong to the technical scope of the present invention. Components in the embodiment described above may be combined freely within a range not departing from the spirit of the invention.

At least the following matters are described in the present description. Although corresponding components in the above embodiment are shown in parentheses, the present invention is not limited thereto.

(1) A vehicle (vehicle V), including:

a vehicle interior;

a first temperature adjustment circuit (first temperature adjustment circuit C1) including a compressor (compressor 5), a condenser (condenser 6), an expansion valve (expansion valve 8), and an evaporator (evaporator 7), the first temperature adjustment circuit being configured to cool the vehicle interior;

a battery (battery 1) configured to be charged by receiving electric power from an external power supply;

a second temperature adjustment circuit (second temperature adjustment circuit C2) configured to cool the battery;

a heat exchange part (chiller 2) configured to perform heat exchange between a first medium flowing through the first temperature adjustment circuit and a second medium flowing through the second temperature adjustment circuit; and

a control device (control device CTR) configured to control the first temperature adjustment circuit and the second temperature adjustment circuit,

in which during charging of the battery by the external power supply, the control device is configured to:
cool the battery by controlling the second temperature adjustment circuit; and
when a state of charge of the battery is equal to or greater than a predetermined value (SOC1) and a vehicle interior temperature-related value related to a temperature of the vehicle interior is equal to or greater than a threshold (T1), cool the vehicle interior by controlling the first temperature adjustment circuit.

According to (1), by cooling the vehicle interior during charging of the battery, it is possible to prevent an event in which output of the battery is limited due to cooling capacity of the first temperature adjustment circuit being used for cooling of the vehicle interior when the vehicle travels immediately after charging of the battery.

In addition, by cooling the vehicle interior only when the state of charge of the battery is equal to or greater than the predetermined value, the vehicle interior can be cooled using surplus cooling capacity of the first temperature adjustment circuit after a heat generation amount of the battery decreases, and the battery during external charging can be appropriately cooled.

(2) The vehicle according to (1),

in which when cooling the vehicle interior during charging of the battery, the control device assigns cooling capacity of the first temperature adjustment circuit to cooling of the battery in preference to cooling of the vehicle interior.

According to (2), heat generation of the battery can be suppressed by cooling the battery in a preferential manner.

(3) The vehicle according to (2),

in which the cooling capacity of the first temperature adjustment circuit assigned to cooling of the battery is determined based on a threshold temperature at which output of the battery is limited and based on a temperature of the battery during charging.

According to (3), the heat generation of the battery can be more appropriately suppressed.

(4) The vehicle according to (3),

in which when the vehicle travels after charging of the battery, the control device assigns the cooling capacity of the first temperature adjustment circuit to cooling of the battery in preference to cooling of the vehicle interior so that the temperature of the battery does not exceed the threshold temperature.

According to (4), it is possible to more appropriately suppress an event in which the output of the battery is limited when the vehicle travels after charging of the battery.

(5) The vehicle according to any one of (1) to (4),

in which the control device ends cooling of the vehicle interior when charging of the battery ends.

According to (5), it is possible to avoid an occurrence that the state of charge of the battery decreases due to cooling the vehicle interior.

(6) The vehicle according to any one of (1) to (5),

in which the control device cools the vehicle interior during charging of the battery only when permission is given by a user.

According to (6), it is possible to avoid an occurrence that the vehicle interior is cooled in a state where permission is not given by the user.

(7) The vehicle according to any one of (1) to (6),

in which the control device cools the vehicle interior during charging of the battery when an interval between a scheduled end time of charging of the battery and a traveling start time is equal to or less than a predetermined time based on a charging schedule and a traveling schedule.

According to (7), it is possible to avoid unnecessary cooling of the vehicle interior by determining whether to cool the vehicle interior based on the charging schedule and the traveling schedule. In addition, when the vehicle travels after charging of the battery, the cooling capacity of the first temperature adjustment circuit is used to cool the vehicle interior, and thus it is possible to prevent the event in which the output of the battery is limited.

(8) The vehicle according to any one of (1) to (7),

in which the battery is charged by constant current control until the state of charge of the battery reaches the predetermined value, and is charged by constant voltage control when the state of charge of the battery is equal to or greater than the predetermined value.

According to (8), since heat generation of the battery during charging is smaller during the constant voltage control than during the constant current control, the cooling capacity of the first temperature adjustment circuit assigned to cooling of the battery is reduced. Therefore, during the constant voltage control, the cooling capacity of the first temperature adjustment circuit can be used to cool the vehicle interior.

(9) A vehicle (vehicle V), including:

a vehicle interior;

a first temperature adjustment circuit (first temperature adjustment circuit C1) including a compressor (compressor 5), a condenser (condenser 6), an expansion valve (expansion valve 8), and an evaporator (evaporator 7), the first temperature adjustment circuit being configured to cool the vehicle interior;

a battery (battery 1) configured to be charged by receiving electric power from an external power supply;

a second temperature adjustment circuit (second temperature adjustment circuit C2) configured to cool the battery;

a heat exchange part (chiller 2) configured to perform heat exchange between a first medium flowing through the first temperature adjustment circuit and a second medium flowing through the second temperature adjustment circuit; and

a control device (control device CTR) configured to control the first temperature adjustment circuit and the second temperature adjustment circuit,

in which during charging of the battery by the external power supply, the control device is configured to:
prohibit cooling of the vehicle interior by controlling the first temperature adjustment circuit while charging of the battery is under constant current control, and
permits cooling of the vehicle interior by controlling the first temperature adjustment circuit after charging of the battery is shifted from the constant current control to constant voltage control.

According to (9), since heat generation of the battery during charging is smaller during the constant voltage control than during the constant current control, cooling capacity of the first temperature adjustment circuit assigned to cooling of the battery is reduced. Thus, during the constant voltage control, the cooling capacity of the first temperature adjustment circuit can be used to cool the vehicle interior. Therefore, the vehicle interior can be cooled after charging of the battery is shifted from the constant current control to the constant voltage control. Accordingly, it is possible to cool the battery during external charging appropriately, and it is possible to prevent an event in which output of the battery is limited due to the cooling capacity of the first temperature adjustment circuit being used for cooling of the vehicle interior when the vehicle travels after charging of the battery.

(10) The vehicle according to (9),

in which the vehicle interior is cooled by using electric power from the external power supply.

According to (10), the vehicle interior is cooled by using surplus electric power from the external power supply after charging of the battery is shifted from the constant current control to the constant voltage control, and thus charging of the battery and cooling of the vehicle interior can be performed economically and efficiently in a charging station where a fee is charged according to charging time.

What is claimed is:

1. A vehicle comprising:
a vehicle interior;
a first temperature adjustment circuit including a compressor, a condenser, an expansion valve, and an evaporator, the first temperature adjustment circuit being configured to cool the vehicle interior;
a battery configured to be charged by receiving electric power from an external power supply;
a second temperature adjustment circuit configured to cool the battery;
a heat exchange part configured to perform heat exchange between a first medium flowing through the first temperature adjustment circuit and a second medium flowing through the second temperature adjustment circuit; and
a control device configured to control the first temperature adjustment circuit and the second temperature adjustment circuit,
wherein during charging of the battery by the external power supply, the control device is configured to:
cool the battery by controlling the second temperature adjustment circuit; and
when a state of charge of the battery is equal to or greater than a predetermined value and a vehicle interior temperature-related value related to a temperature of the vehicle interior is equal to or greater than a threshold, cool the vehicle interior by controlling the first temperature adjustment circuit.

2. The vehicle according to claim 1,
wherein when cooling the vehicle interior during charging of the battery, the control device assigns cooling capacity of the first temperature adjustment circuit to cooling of the battery in preference to cooling of the vehicle interior.

3. The vehicle according to claim 2,
wherein the cooling capacity of the first temperature adjustment circuit assigned to cooling of the battery is determined based on a threshold temperature at which output of the battery is limited and based on a temperature of the battery during charging.

4. The vehicle according to claim 3,
wherein when the vehicle travels after charging of the battery, the control device assigns the cooling capacity of the first temperature adjustment circuit to cooling of the battery in preference to cooling of the vehicle interior so that the temperature of the battery does not exceed the threshold temperature.

5. The vehicle according to claim 1,
wherein the control device ends cooling of the vehicle interior when charging of the battery ends.

6. The vehicle according to claim 1,
wherein the control device cools the vehicle interior during charging of the battery only when permission is given by a user.

7. The vehicle according to claim 1,
wherein the control device cools the vehicle interior during charging of the battery when an interval between a scheduled end time of charging of the battery and a traveling start time is equal to or less than a predetermined time based on a charging schedule and a traveling schedule.

8. The vehicle according to claim 1,
wherein the battery is charged by constant current control until the state of charge of the battery reaches the predetermined value, and is charged by constant voltage control when the state of charge of the battery is equal to or greater than the predetermined value.

9. A vehicle comprising:
a vehicle interior;
a first temperature adjustment circuit including a compressor, a condenser, an expansion valve, and an evaporator and the first temperature adjustment circuit being configured to cool the vehicle interior;
a battery configured to be charged by receiving electric power from an external power supply;
a second temperature adjustment circuit configured to cool the battery;
a heat exchange part configured to perform heat exchange between a first medium flowing through the first temperature adjustment circuit and a second medium flowing through the second temperature adjustment circuit; and
a control device configured to control the first temperature adjustment circuit and the second temperature adjustment circuit,
wherein during charging of the battery by the external power supply, the control device is configured to:
prohibit cooling of the vehicle interior by controlling the first temperature adjustment circuit while charging of the battery is under constant current control; and
permit cooling of the vehicle interior by controlling the first temperature adjustment circuit after charging of the battery is shifted from the constant current control to constant voltage control.

10. The vehicle according to claim 9,
wherein the vehicle interior is cooled by using electric power from the external power supply.
